(19) United States
(12) Patent Application Publication
(10) Pub. No.: US 2009/0083982 A1
(43) Pub. Date: Apr. 2, 2009

(54) Decreasing blade spans

(75) Inventor: Edward Neill Forsdike, Reading (GB)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Gillette Company

(21) Appl. No.: 11/904,878

(22) Filed: Sep. 28, 2007

(51) Int. Cl. B26B 19/42; B26B 19/00; B26B 21/14

(52) U.S. Cl. 30/34.2; 30/34.05; 30/78; 30/77; 30/84

(57) ABSTRACT

A safety razor cartridge includes a plurality of elongated blades disposed in a housing between a guard and a cap. The blades have substantially parallel sharp cutting edges. The plurality has first, second, and third consecutively disposed cutting edges. A distance between the first and second cutting edges is greater than a distance between the second and third cutting edges.

### FIELD OF THE INVENTION

This invention relates to safety razors for wet shaving and, more specifically, to safety razor cartridges having at least three cutting edges.

### BACKGROUND OF THE INVENTION

Safety razors used for wet shaving are well known. Some razors include multiple blades having sharp cutting edges. Increasing the number of blades on a safety razor generally tends to increase the shaving efficiency of the razor and provide better distribution of compressive forces on the skin.

When a hair is engaged by a blade cutting edge, the cutting forces may extend the hair from the skin. After the hair is extended, it does not immediately retract into the skin. A second blade may further cut the hair before it fully retracts, so-called “hysteresis cutting,” resulting in a closer shave. Safety razors with multiple blades may provide multiple cutting and extending events and multiple opportunities for hysteresis cutting.

When more than one blade engages the same hair at the same time, a so-called “double engagement,” may result in an uncomfortable pulling sensation. Consumers who shave less frequently may have generally longer hair growth at any given shave and may be more susceptible to discomfort from double engagement.

The distance between consecutive cutting edges or so-called “span” is theorized to affect the shaving process in several ways. The span between cutting edges may control the degree to which skin will bulge between blades, with smaller spans resulting in less skin bulge and more skin comfort during shaving, but may also increase opportunities for double engagement. Larger spans may reduce opportunities for double engagements but may result in more skin bulge between cutting edges and less skin comfort. Span between cutting edges and, thus between blades, may affect rinsing of shave prep and shave debris after a shaving stroke, with larger spans easing or quickening rinsing and smaller spans slowing or making rinsing more difficult.

Some safety razors have cutting edges with substantially the same span. The span between the guard and the first cutting edge may be the same or different than the span between cutting edges. The span between the last cutting edge and the cap may be the same or different than the span between cutting edges.

### SUMMARY OF THE INVENTION

This invention relates to safety razors for wet shaving and, more specifically, to safety razor cartridges having at least three cutting edges.

In one aspect, the invention features, in general, a safety razor cartridge having a plurality of elongated blades disposed in a housing between a guard and a cap. The blades have substantially parallel sharp cutting edges. The plurality has first, second, and third consecutively disposed cutting edges. A distance between the first and second cutting edges is greater than a distance between the second and third cutting edges.

Certain implementations of the invention may include one or more of the following features. The distance between the first and second cutting edges is between about 1.2 mm and 0.9 mm. The distance between the first and second cutting edges is about 1.05 mm. The distance between the second and third cutting edges is between about 1.15 mm and 0.75 mm. The distance between the second and third cutting edges is about 0.9 mm. The distance between the guard and the first cutting edge is greater than the distance between the first cutting edge and the second cutting edge. The distance between the guard and the first cutting edge is between about 1.55 mm and 1.25 mm. The distance between the guard and the first cutting edge is about 1.4 mm. The plurality has a fourth cutting edge disposed consecutively after the third edge, wherein the distance between the second and third cutting edges is at least substantially the same as a distance between the third and fourth cutting edges. The distance between the second and third cutting edges is greater than the distance between the third and fourth cutting edges. The distance between the third and fourth cutting edges is between about 0.95 mm and 0.65 mm. The distance between the third and fourth cutting edges is about 0.8 mm. The plurality has a fifth cutting edge disposed consecutively after the fourth cutting edge, wherein the distance between the third and fourth cutting edges is at least substantially the same as a distance between the fourth and fifth cutting edges. The distance between the third and fourth cutting edges is greater than the distance between the fourth and fifth cutting edges. The distance between the fourth and fifth cutting edges is between about 0.85 mm and 0.55 mm. The distance between the fourth and fifth cutting edges is about 0.7 mm. The cap comprises a lubricious shaving aid. The guard comprises an elastomeric skin stretching member.

### BRIEF DESCRIPTION OF THE DRAWINGS

FIG. 1 is an isometric view of a shaving razor of the present invention;

FIG. 2 is an isometric view of the FIG. 1 razor showing its replaceable cartridge separated from its handle; and

FIG. 3 is a partial section view of a cartridge of FIGS. 1 and 2 in a plane substantially perpendicular to the cartridge blade edges showing the relative positions of some of the cartridge components.

FIGS. 4A-4C are partial top views of a blade and three different guards.

### DETAILED DESCRIPTION OF THE INVENTION

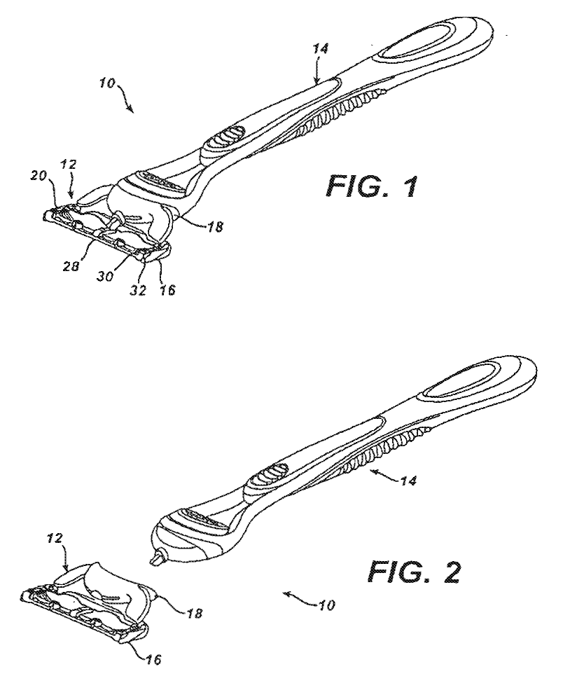

Referring to FIGS. 1 and 2, in some examples, shaving razor 10 includes disposable cartridge 12 and handle 14. Cartridge 12 includes a connecting member 18 for detachably connecting handle 14 and blade unit 16, which is pivotally connected to connecting member 18. Blade unit 16 includes plastic housing 20 and five elongated blades 28a, 28b, 28c, 28d, 28e between guard 22 at the front of housing 20 and cap 24 with lubricating strip 26 at the rear of housing 20 and retained by clips 32.

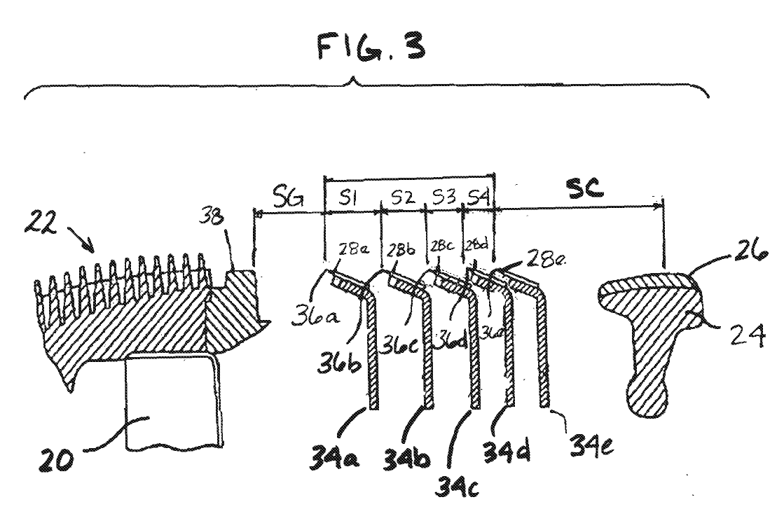

Referring to FIG. 3, each elongated blade 28a, 28b, 28c, 28d, 28e is supported on a respective elongated support 34a, 34b, 34c, 34d, 34e that may be fixed within housing 20 or supported to allow movement of the blade 28 during shaving, as is well known in the art. Any suitable blade support structure or combination of blade and support may be used.

In some examples, cutting edges 36a, 36b, 36c, 36d, 36e are separated from preceding skin contacting elements by a progressively decreasing blade span. By taking into account a change in hair length as it progresses from the front to the rear of cartridge 12, shaving is optimized as the hair-skin system changes. The blade span is defined as the distance from the blade cutting edge to the skin contacting element immediately in front of that edge as measured along a tangent line extending between the element and the blade edge in a plane substantially perpendicular to the blade edge. The spans may be wider toward the front of the cartridge, where longer hairs may be encountered, to minimize double engagement. The spans may be narrower toward the rear of the cartridge, where shorter hairs may be encountered, to maximize the opportunity for hysteresis cutting and to reduce skin bulge for greater skin comfort.

In some examples, blade span S1 between blade edges 36a and 36b is greater than blade span S2 between blade edges 36b and 36c, which is greater than blade span S3 between blade edges 36c and 36d, which is greater than blade span S4 between blade edges 36d and 36e. In one example, blade span S1 preferably is between about 1.2 mm and 0.9 mm, more preferably about 1.05 mm, blade span S2 preferably is between about 1.15 mm and 0.75 mm, more preferably about 0.9 mm, blade span S3 preferably is between about 0.95 mm and 0.65 mm, more preferably about 0.8 mm, and blade span S4 preferably is between about 0.85 mm and 0.55 mm, more preferably about 0.7 mm. The total blade span ST preferably is between about 4.15 mm and 2.85 mm, more preferably about 3.45 mm. In other examples, more than five blades could be used, such as six or seven blades, for example, with progressively decreasing spans therebetween.

In other examples, a combination of equal and progressively decreasing spans may be used. For example, span S1 may be equal to span S2 and both greater than progressively decreasing spans S3 and S4. In another example, span S1 may be greater than equal spans S2 and S3, which are greater than spans S4. The terms “first,” “second,” “third,” “fourth,” and “fifth” used herein to identify an order of elements should be understood as only relating to other such identified elements and not limiting the proximity of those elements to other cartridge features (e.g., a “first blade” is not limited to the blade closest to the guard).

Shaving razors with progressively decreasing blade spans may result in smaller cartridge dimensions than that of razors with uniform blade spans between the same number of blades without sacrificing shaving performance. For example, testing of the example cartridge geometry E1 described in Table 1 against the geometry of the commercially available Gillette Fusion™ cartridge showed performance parity with that blade geometry.

TABLE 1

| | Fusion ™ | E1 |
|---|---|---|
| | Spans (mm) | Spans (mm) |
| SG | 0.7 | 0.7 |
| S1 | 1.05 | 1.05 |
| S2 | 1.05 | 0.9 |
| S3 | 1.05 | 0.8 |
| S4 | 1.05 | 0.7 |

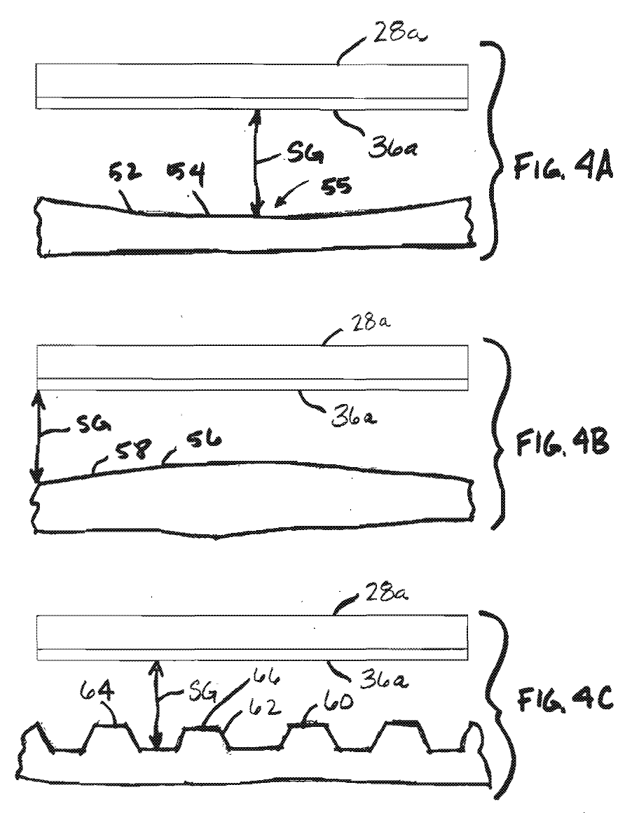

Referring to FIGS. 3 and 4A-4C, in some examples, increasing guard span SG may improve feeding of hairs in front of blade 28a and may result in greater hair removal. Generally, the guard span will be the distance between the last skin engaging feature of the guard (e.g., housing rail 38) and the first cutting edge (e.g., cutting edge 36a) measured along a tangent line extending between two cutting edges 36 in a plane substantially perpendicular to a cutting edge. In some examples, this distance will be substantially the same along the entire length of the cutting edge. In other examples, however, the distance will change because the last skin engaging feature is not linear or not parallel to the cutting edge. For example, guard 52 has a concave edge 54, guard 56 has a convex edge 58, and guard 60 has a toothed edge 62. In such cases, the guard span SG should be measured between the cutting edge and the part of the last skin engaging feature furthest from the cutting edge. In this way, the guard span SG generally represents the longest hairs that may be fed in front of the first cutting edge. Thus, guard span SG between cutting edge 36a and guard 52 is measured at the middle portion 55 of concave edge 54, guard span SG between cutting edge 36a and guard 56 is measured at the side portion 59 of convex edge 58, and guard span SG between cutting edge 36a and guard 60 is measured between teeth 64 and 66.

Increasing guard span SG results in blades 28 being disposed further towards the rear of blade unit 16, increasing the loading on and therefore the cutting efficiency of the trailing blade. While progressively decreasing blade spans may be incorporated with any suitable guard span, in one example guard span SG preferably is between about 1.25 mm and 1.55 mm, more preferably about 1.4 mm.

An example cartridge geometry E2 described in Table 2 was tested against the cartridge geometry of the commercially available Gillette Fusion™ cartridge by men having 72 hours of facial hair growth. The E2 geometry was significantly preferred over the Fusion™ cartridge geometry for overall shaving performance, comfort, and efficiency.

TABLE 2

| | Fusion ™ | E2 |
|---|---|---|
| | Spans (mm) | Spans (mm) |
| SG | 0.7 | 1.4 |
| S1 | 1.05 | 1.05 |
| S2 | 1.05 | 0.9 |
| S3 | 1.05 | 0.8 |
| S4 | 1.05 | 0.7 |

A similar test of the E2 geometry against the Gillette Fusion™ cartridge geometry by men having 24 hours of facial hair growth found no significant preference between the two geometries. This indicates that the progressively decreasing geometry of E2 performs better for infrequent shavers without sacrificing performance for daily shavers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A safety razor cartridge, comprising:
a plurality of elongated blades disposed in a housing between a guard and a cap and having substantially parallel sharp cutting edges;
wherein the plurality comprises first, second, and third consecutively disposed cutting edges and a distance between the first and second cutting edges is greater than a distance between the second and third cutting edges.

2. The safety razor cartridge of claim 1, wherein the distance between the first and second cutting edges is between about 1.2 mm and 0.9 mm.

3. The safety razor cartridge of claim 2, wherein the distance between the first and second cutting edges is about 1.05 mm.

4. The safety razor cartridge of claim 1, wherein the distance between the second and third cutting edges is between about 1.15 mm and 0.75 mm.

5. The safety razor cartridge of claim 4, wherein the distance between the second and third cutting edges is about 0.9 mm.

6. The safety razor cartridge of claim 1, wherein a distance between the guard and the first cutting edge is greater than the distance between the first cutting edge and the second cutting edge.

7. The safety razor cartridge of claim 6, wherein the distance between the guard and the first cutting edge is between about 1.25 mm and 1.55 mm.

8. The safety razor cartridge of claim 7, wherein the distance between the guard and the first cutting edge is about 1.4 mm.

9. The safety razor cartridge of claim 1, wherein the plurality further comprises a fourth cutting edge disposed consecutively after the third edge, wherein the distance between the second and third cutting edges is at least substantially the same as a distance between the third and fourth cutting edges.

10. The safety razor cartridge of claim 9, wherein the distance between the second and third cutting edges is greater than the distance between the third and fourth cutting edges.

11. The safety razor cartridge of claim 10, wherein the distance between the third and fourth cutting edges is between about 0.95 mm and 0.65 mm.

12. The safety razor cartridge of claim 9, wherein the distance between the third and fourth cutting edges is about 0.8 mm.

13. The safety razor cartridge of claim 9, wherein the plurality further comprises a fifth cutting edge disposed consecutively after the fourth cutting edge, wherein the distance between the third and fourth cutting edges is at least substantially the same as a distance between the fourth and fifth cutting edges.

14. The safety razor cartridge of claim 13, wherein the distance between the third and fourth cutting edges is greater than the distance between the fourth and fifth cutting edges.

15. The safety razor cartridge of claim 13, wherein the distance between the fourth and fifth cutting edges is between about 0.85 mm and 0.55 mm.

16. The safety razor cartridge of claim 15, wherein the distance between the fourth and fifth cutting edges is about 0.7 mm.

17. The safety razor cartridge of claim 1, wherein the cap comprises a lubricious shaving aid.

18. The safety razor cartridge of claim 1, wherein the guard comprises an elastomeric skin stretching member.
